(19) United States
(12) Patent Application Publication
(10) Pub. No.: US 2008/0297319 A1
(43) Pub. Date: Dec. 4, 2008

(54) Article management system

(75) Inventors: Hisashi Ohtani, Tochigi (JP); Jun Koyama, Sagamihara (JP); Shunpei Yamazaki, Setagaya (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 12/153,643

(22) Filed: May 22, 2008

(30) Foreign Application Priority Data
May 29, 2007 (JP) 2007-142387

(51) Int. Cl. H04Q 5/22

(52) U.S. Cl. 340/10.1

(57) ABSTRACT

An article management system which can efficiently search for the whereabouts of an article. The article management system for managing the whereabouts of an article existing in any of a plurality of sections includes radio communication devices provided in the respective sections, and an RFID tag and a portable device that are communicable with the radio communication device by radio. The RFID tag is attached to the article. The article is detected through communication between the RFID tag and one of the radio communication devices provided in the respective sections. Further, in which of the plurality of sections the article exists is specified through communication between the portable device and the radio communication devices provided in the respective sections.

### BACKGROUND OF THE INVENTION

1. Field of the Invention

The present invention relates to article management systems and, more particularly, to an article management system which controls articles via radio communication.

2. Description of the Related Art

Generally, when a plurality of trade articles are to be managed, data on the articles is registered in a database and the articles are put in a predetermined place, for example. Meanwhile, articles such as daily commodities are usually not managed individually. Therefore, when the articles are moved to another place, there has been a possibility that the whereabouts of the articles become uncertain and, thus, the articles have to be searched for over a long time. Consequently, the place of the articles should be memorized by humans on an as-needed basis.

However, it is difficult for humans to remember the place of the articles at all times. In particular, as the time passes or the humans get older, they will have short memories and it becomes more difficult for them to remember the place of the articles. Further, even when they remember the place of the articles, they have to search for the articles if the articles are moved to another place by the third party.

In order to solve the foregoing problems, an article management system which searches for lost articles has been developed, in which an RFID tag that stores predetermined information is attached to an article and the article is searched about with an RFID reading/communication device (for example, see Reference 1: Japanese Published Patent Application No. 2005-71193).

### SUMMARY OF THE INVENTION

However, concerning the method of searching for an article with an RFID reading/communication device for reading out an RFID tag attached to the article, it is difficult to search for the article efficiently if the range of the searched area is large. In addition, when the size of the RFID reading/communication device is reduced, the communicable range of the RFID tag attached to the article and the RFID reading/communication device becomes small and, thus, the search for the article can be difficult.

In view of the foregoing problems, it is an object of the present invention to search for the whereabouts of articles efficiently. It is another object of the present invention to suppress failures of article management due to a decrease in communication distance even when the size of a portable device is reduced.

One aspect of the present invention is an article management system for managing the whereabouts of an article existing in any of a plurality of sections, which includes radio communication devices provided in the respective sections, and an RFID tag and a portable device that are communicable with the radio communication devices by radio. The RFID tag is attached to the article. The article is detected through communication between the RFID tag and one of the radio communication devices provided in the respective sections. In which of the plurality of sections the article exists is specified through communication between the portable device and the radio communication devices provided in the respective sections.

One aspect of the present invention is an article management system for managing the whereabouts of a plurality of articles existing in any of a plurality of sections, which includes radio communication devices provided in the respective sections, and RFID tags and a portable device that are communicable with the respective radio communication devices by radio. The RFID tags are attached to the respective articles. The articles existing in the respective sections are detected through communication between the RFID tags and the radio communication devices provided in the respective sections. In which of the plurality of sections each of the plurality of articles exists is specified through communication between the portable device and the radio communication devices provided in the respective sections.

One aspect of the present invention is the article management system with the aforementioned configuration, in which the radio communication device includes a first antenna and a second antenna, the radio communication device communicates with the RFID tag via the first antenna, and the radio communication device communicates with the portable device via the second antenna.

One aspect of the present invention is an article management system for managing the whereabouts of an article existing in any of a plurality of sections, which includes radio communication devices provided in the respective sections, a plurality of readers/writers provided in each section, an RFID tag communicable with the readers/writers by radio, and a portable device communicable with the radio communication devices by radio. The plurality of readers/writers are connected to the radio communication device provided in the same section. The RFID tag is attached to the article. The article and the position of the article are detected through communication between the RFID tag and the plurality of readers/writers. In which of the plurality of sections the article exists and the position of the article within the section are specified through communication between the portable device and the radio communication devices provided in the respective sections.

One aspect of the present invention is the article management system with the aforementioned configuration, in which Bluetooth® is utilized as a communication method between the ratio communication devices and the portable device.

By providing a radio communication device in each of predetermined sections and accessing the radio communication device with a portable device, it is possible to efficiently search for in which of the sections a search article is located. Further, even when the size of the portable device is reduced, it is possible to suppress a drop in communication distance between the radio communication device and an RFID tag attached to the article. Thus, article management can be carried out with accuracy.

### BRIEF DESCRIPTION OF THE DRAWINGS

In the accompanying drawings:

FIG. 1 illustrates an exemplary article management system of the present invention;

FIG. 2 illustrates the configuration of a radio communication device of an article management system of the present invention;

FIG. 3 illustrates an exemplary article management system of the present invention;

FIG. 4 illustrates an exemplary article management system of the present invention;

FIG. 5 illustrates the configuration of a radio communication device of an article management system of the present invention;

FIG. 6 illustrates the configuration of a radio communication device of an article management system of the present invention;

FIG. 7 illustrates an exemplary RFID tag of an article management system of the present invention;

FIG. 8 illustrates an exemplary article management system of the present invention; and

FIG. 9 illustrates an exemplary article management system of the present invention.

### DETAILED DESCRIPTION OF THE INVENTION

### Embodiment Mode

Hereinafter, embodiment modes of the present invention will be described with reference to the accompanying drawings. Note that it will be easily understood by those skilled in the art that the present invention can be embodied in various different ways and, therefore, various modifications and variations can be made to the present invention without departing from the spirit and the scope thereof. Thus, the present invention should not be construed as being limited to the description in the following embodiment modes. Note that portions that are the same or have similar functions will be denoted by the same reference numerals in the drawings of this specification.

### Embodiment Mode 1

This embodiment mode will describe an exemplary article management system with reference to drawings.

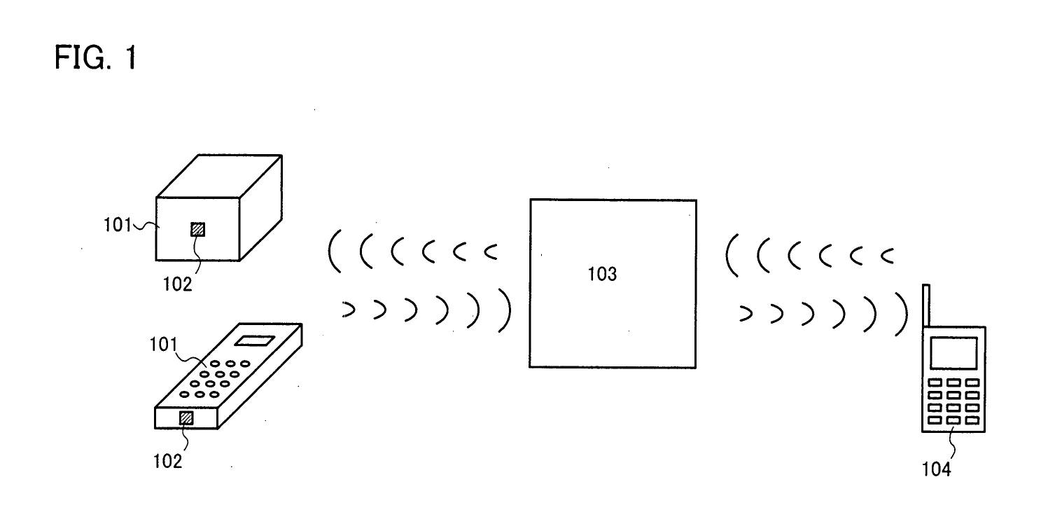

The article management system illustrated in this embodiment mode has a semiconductor device capable of radio transmission and reception of data (also called an RFID tag, an IC tag, an RF tag, a wireless tag, or an electronic tag; hereinafter referred to as an “RFID tag”), a radio communication device, and a portable device. The whereabouts of an article to which the RFID tag is attached is grasped by communication between the radio communication device and the portable device. An exemplary article management system will be described in detail with reference to FIG. 1.

The article management system illustrated in FIG. 1 includes an RFID tag 102 attached to an article 101, a radio communication device 103, a portable device 104, and the like.

The radio communication device 103 can communicate with the RFID tag 102 and the portable device 104 by radio. Users can grasp the whereabouts of the article 101, to which the RFID tag 102 existing in the communicable range of the radio communication device 103 is attached, by accessing the radio communication device 103 using the portable device 104.

The RFID tag 102 is acceptable as long as it can communicate with the radio communication device 103 by radio. The transmission method of electromagnetic waves applied to the RFID tag 102 and the radio communication device 103 can be any of an electromagnetic coupling method, an electromagnetic induction method, a microwave method, and the like. The transmission method may be determined by a practitioner by appropriately taking into consideration the use of the system. An antenna with an optimal length and shape may be provided in accordance with the transmission method.

For example, when an electromagnetic coupling method or an electromagnetic induction method (e.g., 13.56 MHz band) is applied as the transmission method, a conductive film functioning as an antenna is formed in a loop shape (e.g., a loop antenna) or in a spiral shape (e.g., a spiral antenna) in order to utilize electromagnetic induction. When a microwave method (e.g., UHF band (860 to 960 MHz), 2.45 GHz band, or the like) is applied as the transmission method, the length and the shape of a conductive film functioning as an antenna may be determined as appropriate according to the wavelength of electromagnetic waves used for signal transmission. For example, the conductive film functioning as the antenna can be formed in a linear shape (e.g., a dipole antenna), a flat shape (e.g., a patch antenna), or the like. Further, the shape of the conductive film functioning as the antenna is not limited to a linear shape. The antenna may be formed in a curved-line shape or in a serpentine shape in consideration of the wavelength of electromagnetic waves. Alternatively, the antenna may have a combination of such shapes.

In this embodiment mode, the UHF band is applied as the transmission method. Applying the UHF band ensures the communication distance between the radio communication device 103 and the RFID tag 102 and can conduct excellent communication.

The portable device 104 is acceptable as long as it can communicate with the radio communication device 103 by radio. For example, a mobile phone, a computer, or the like can be used. In addition, the portable device 104 does no need to be a device that can be carried about, but may be a computer or the like that is fixed in some place. A communication method between the portable device 104 and the radio communication device 103 can be Bluetooth®, Wibree, or the like; however, the present invention is not limited to these. Note that Bluetooth® is one of the short-range radio communication technologies used for connection of devices that are several meters to several tens of meters away from each other, using a frequency band of 2.4 GHz. Wibree is also one of the short-range radio communication techniques used for connection of devices that are several meters to several tens of meters away from each other. Wibree has lower power consumption than Bluetooth®.

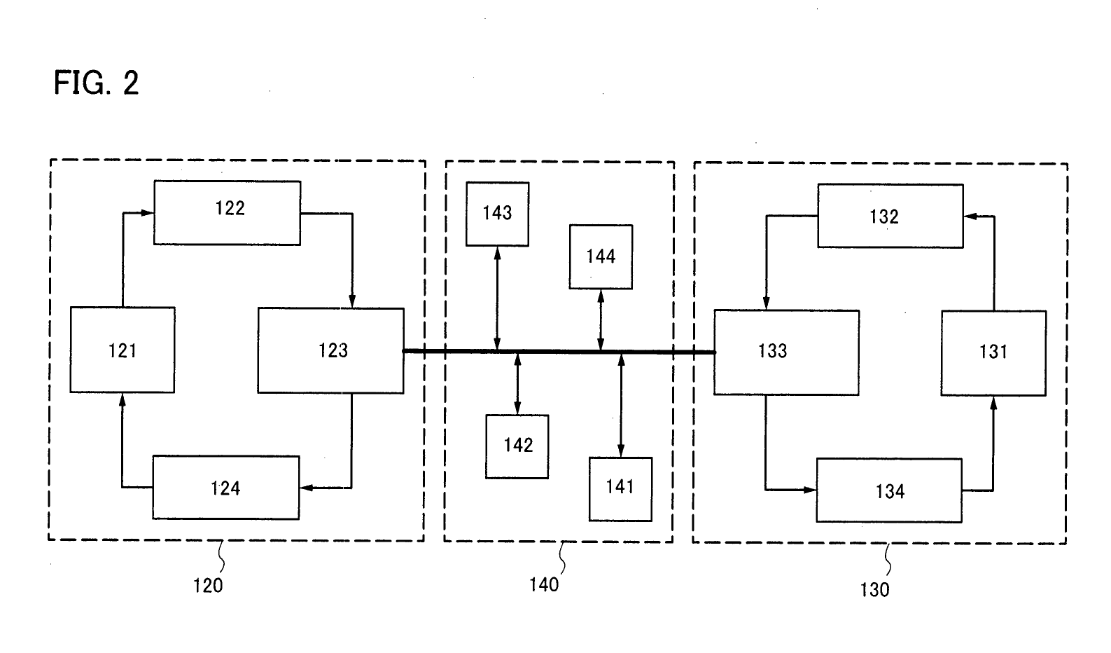

The radio communication device 103 is acceptable as long as it can communicate with the RFID tag 102 and the portable device 104 by radio. Hereinafter, a specific configuration of the radio communication device 103 will be described with reference to FIG. 2.

The radio communication device 103 illustrated in FIG. 2 includes an R/W block 120 which controls communication with the RFID tag 102, a Bluetooth communication block 130 which controls communication with the portable device 104, and a control block 140 which processes information obtained through communication.

The R/W block 120 includes a first antenna 121, a first demodulation circuit 122, a first signal processing circuit 123, a first modulation circuit 124, and the like. The R/W block 120 transmits and receives information to/from the RFID tag 102 by radio via the first antenna 121. The transmission method of electromagnetic waves applied to the R/W block 120 and the RFID tag 102 can be any of an electromagnetic coupling method, an electromagnetic induction method, a microwave method, and the like.

The Bluetooth communication block 130 includes a second antenna 131, a second demodulation circuit 132, a second signal processing circuit 133, a second modulation circuit 134, and the like. The Bluetooth communication block 130 transmits and receives information to/from the portable device 104 by radio via the second antenna 131. Using a frequency band of 2.4 GHz (here, Bluetooth®) as the communication method between the radio communication device 103 and the portable device 104 is advantageous in that excellent communication can be easily carried out.

Although FIG. 2 illustrates the case where Bluetooth® is used as the communication method between the radio communication device 103 and the portable device 104, the present invention is not limited to this. For example, a method other than Bluetooth®, such as Wibree can also be used as the communication method between the radio communication device 103 and the portable device 104.

The control block 140 includes a CPU (central processing unit) 141, a HD (hard disk) 142, a ROM (read only memory) 143, a RAM (random access memory) 144, and the like. The CPU 141 performs the processing of information obtained through radio communication, and the like, and the information is stored in the HD 142, the ROM 143, and the RAM 144. Note that not all of the HD 142, the ROM 143, and the RAM 144 are necessarily required to be provided, and it is acceptable as long as some of them are provided.

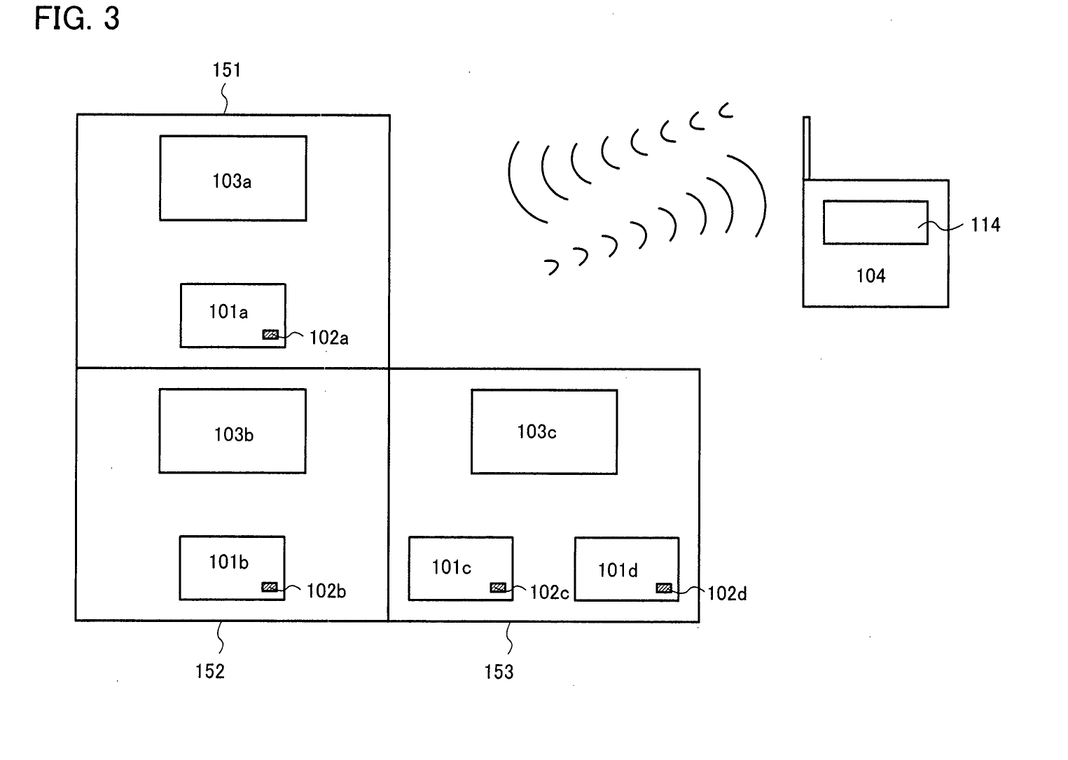

Described next with reference to FIG. 3 is a case where a plurality of sections (rooms) are searched for the whereabouts of an article. In the description of FIG. 3, an article management system is illustrated, with which sections including a first section 151 to a third section 153 are searched for the whereabouts of an article. Note that sections herein mean the ranges of areas obtained by partitioning a room, and the sections may be determined as appropriate according to a place where an article is managed and the like. For example, when the whereabouts of an article is managed at home, it is acceptable as long as a plurality of sections are set by partitioning a space into rooms (for example, a bedroom, a living room, a child's room, and the like).

In the article management system illustrated in FIG. 3, a radio communication device is provided in each of the plurality of sections. Specifically, a first radio communication device 103a, a second radio communication device 103b, and a third radio communication device 103c are provided in the first section 151, the second section 152, and the third section 153, respectively. In addition, a first RFID tag 102a is attached to an article A101a provided in the first section 151, a second RFID tag 102b is attached to an article B101b provided in the second section 152, and a third RFID tag 102c and a fourth RFID tag 102d are attached to an article C101c and an article D101d, respectively which are provided in the third section 153.

The RFID tag attached to each article stores information specific to the article. The first RFID tag 102a stores information specific to the article A101a. Similarly, the second RFID tag 102b to the fourth RFID tag 102d store information specific to the article B101b to the article D101d, respectively.

When the whereabouts of a specific article is to be known, it is possible to specify in which of the first section 151 to the third section 153 the searched article is located, by communicating with the radio communication device 103 using the portable device 104.

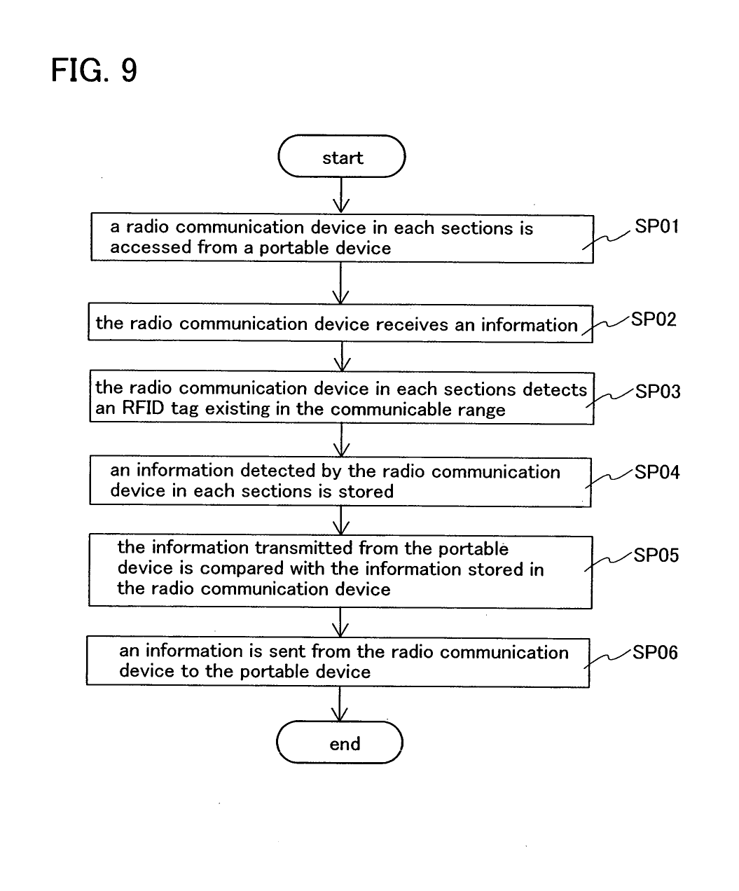

Hereinafter, the operation of searching for a specific article will be described with reference to FIG. 9. Note that the following description illustrates a case where the article C101c is searched for.

First, the radio communication device 103 is accessed (information is transmitted) from the portable device 104 (Step SP01) in order to obtain the whereabouts of a searched article (here, the article C101c). Note that information on the articles existing in the first section 151 to the third section 153 (information on the RFID tags attached to the respective articles) may be registered in the portable device 104 in advance.

Next, the radio communication device 103 receives the information from the portable device 104 (Step SP02) and detects an RFID tag existing in the communicable range (Step SP03). Here, the first radio communication device 103a detects the first RFID tag 102a (the article A101a) existing in the first section 151. Similarly, the second radio communication device 103b detects the second RFID tag 102b (the article B101b) existing in the second section 152. Also, the third radio communication device 103c detects the third RFID tag 102c (the article C101c) and the fourth RFID tag 102d (the article D101d) existing in the third section 153.

The information on the article A101a obtained through communication with the first RFID tag 102a is transmitted to the control block 140 from the first signal processing circuit 123 of the R/W block 120 in the first radio communication device 103a. Then, the information is processed by the CPU 141 and is stored in the HD 142, the ROM 143, the RAM 144, and the like (Step SP04).

Similarly, the information on the article B101b is stored in the HD 142, the ROM 143, the RAM 144, and the like of the second radio communication device 103b, and the information on the article C101c and the article D101d is stored in the HD 142, the ROM 143, the RAM 144, and the like of the third radio communication device 103c.

Next, the information transmitted from the portable device 104 is compared with the information stored in the control blocks 140 of the first radio communication device 103a to the third radio communication device 103c, so that the presence or absence of necessary information (the searched article C101c) is confirmed (Step SP05). Note that the information transmitted from the portable device 104 is input to the control block 140 through the Bluetooth communication block 130.

Next, the comparison results are sent back to the portable device 104 through the Bluetooth communication blocks 130 of the first radio communication device 103a to the third radio communication device 103c (Step SP06). Note that the comparison result may be sent back either by only the radio communication device that has detected the searched article (the article C101c) among the radio communication devices provided in the respective sections or by all of the radio communication devices which include the radio communication devices that have not detected the searched article. In that case, the radio communication devices that have not detected the searched article send information about the detection failure of the searched article, back to the portable device 104.

When the portable device 104 finds the searched article, the portable device 104 displays the section of the article on its display screen 114 to inform users. Here, the portable device 104 displays information about the presence of the article C101c in the third section 153.

In this manner, by accessing the radio communication devices from the portable device 104 to specify the whereabouts of an article, users can efficiently know the whereabouts of the desired article without moving about. In addition, by communicating with RFID tags using the radio communication devices that are provided in the plurality of sections and by using Bluetooth® as a communication method between the portable device and the radio communication devices, it is possible to reduce the size of the portable device without a decrease in communication distance between the RFID tags and the radio communication devices.

Although described above is a case in which the radio communication devices 103a to 103c are accessed from the portable device 104 in order to search for a specific article, it is needless to mention that the article management system illustrated in this embodiment mode can be used for not only the case of searching for specific article but also for building lists of the whereabouts of articles (in which sections the articles are located) and displaying them on the display screen 114 of the portable device 104. In that case, users can easily know where the articles managed by themselves are located without moving about. Further, users can efficiently know what kind of article is present in each section, including articles that are not managed by themselves.

Further, although described above is a method in which the first radio communication device 103a to the third radio communication device 103c detect articles existing in the first section 151 to the third section 153, respectively upon access to the first radio communication device 103a to the third radio communication device 103c from the portable device 104 in search of an article, the present invention is not limited to this method. For example, a configuration may be adopted in which the first radio communication device 103a to the third radio communication device 103c detect articles existing in the first section 151 to the third section 153, respectively at regular time intervals, and store the information in their respective control blocks 140, so that the latest information stored in the radio communication devices is sent back to the portable device 104 upon access from the portable device 104. In that case, time can be saved since the whereabouts of a searched article can be known at the same time as the access. In particular, such a configuration is effective when there are more sections.

In addition, although described above is a case in which the portable device 104 communicates with all of the radio communication devices (the first radio communication device 103a to the third radio communication device 103c), the present invention is not limited to this. For example, the portable device 104 may sequentially communicate with the first radio communication device 103a to the third radio communication device 103c until a searched article is found out, and the communication can be terminated upon detection of the article. In that case, power consumption can be reduced since there is no need to inspect all of the sections. In particular, such a configuration is effective when there are more sections.

Further, a configuration may be adopted in which the plurality of radio communication devices communicate with each other. In that case, as long as one of the plurality of radio communication devices can communicate with the portable device 104, it is possible to know the whereabouts of an article existing in a section, in which a radio communication device that cannot directly communicate with the portable device 104 is provided. Further, users can search for a specific article without moving about while carrying the portable device 104 about.

Note that the article management system illustrated in this embodiment mode is not limited to the configurations described above. For example, when an RFID tag attached to an article can have a configuration with the control block and the Bluetooth communication block illustrated in FIG. 2, article management can be carried out without using the radio communication device, by making the portable device and the RFID tag attached to the article communicate directly with each other. In that case, Bluetooth®, Wibree, or the like can be used as a communication method between the portable device and the RFID tag. Needless to say, the present invention is not limited to such configurations.

### Embodiment Mode 2

This embodiment mode will describe the configuration of an article management system of the present invention with reference to drawings. Specifically, described here is not only a case of detecting the whereabouts of an article to which an RFID tag is attached (in which section the article is located), but also a case of detecting the position of the article within the section.

Note that a position detection method in this embodiment mode will be described by giving an example in which the distance between an RFID tag and a reader/writer and the position of the RFID tag are detected by detecting a decrease in electric field strength in accordance with an increase in propagation distance of a signal in air.

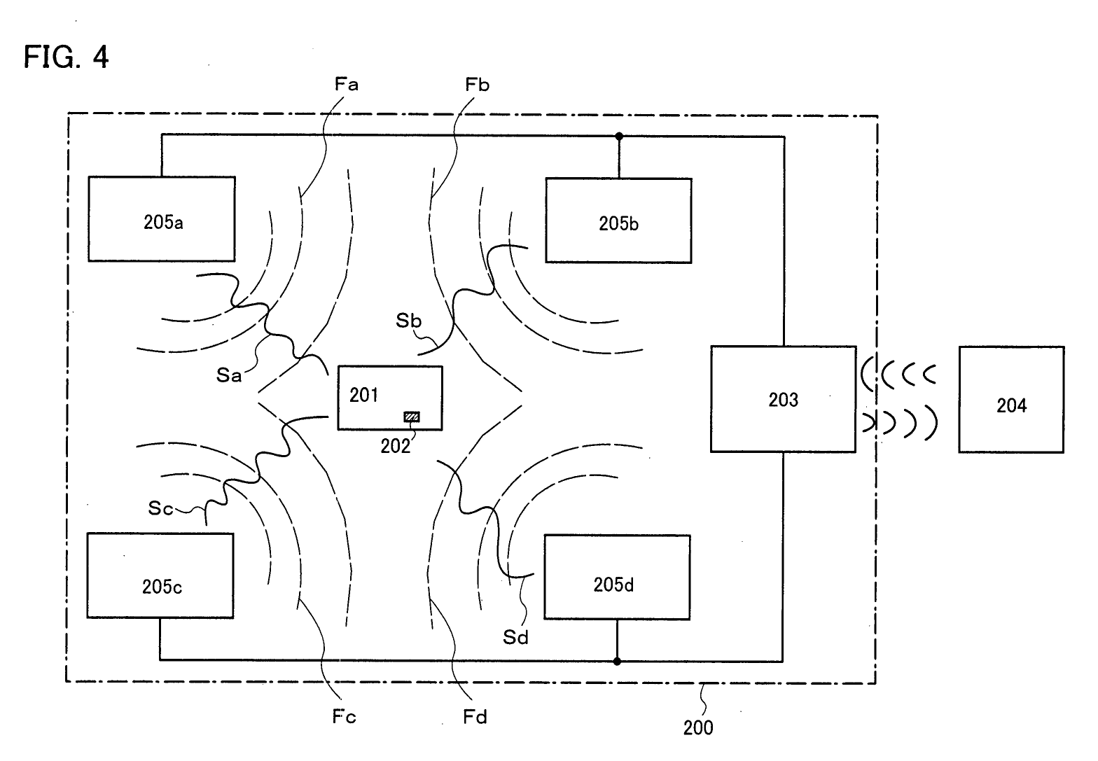

First, the position detection method in this embodiment mode will be described with reference to FIG. 4. FIG. 4 illustrates a case where the position of an RFID tag 202 attached to an article 201 located in a section 200 is detected.

As illustrated in FIG. 4, a plurality of readers/writers (here, a reader/writer 205a to a reader/writer 205d) are provided in the section 200, and the RFID tag 202 is surrounded by the reader/writer 205a to the reader/writer 205d. Needless to say, the number of the readers/writers is not limited to four. At least four readers/writers are required to detect the position of the article 201 to which the RFID tag 202 is attached in three-dimensional space. In addition, at least three readers/writers are required to detect the position of the RFID tag 202 in two-dimensional coordinates. Further, at least one reader/writer is required to measure only the distance between the reader/writer and the RFID tag 202 attached to the article 201.

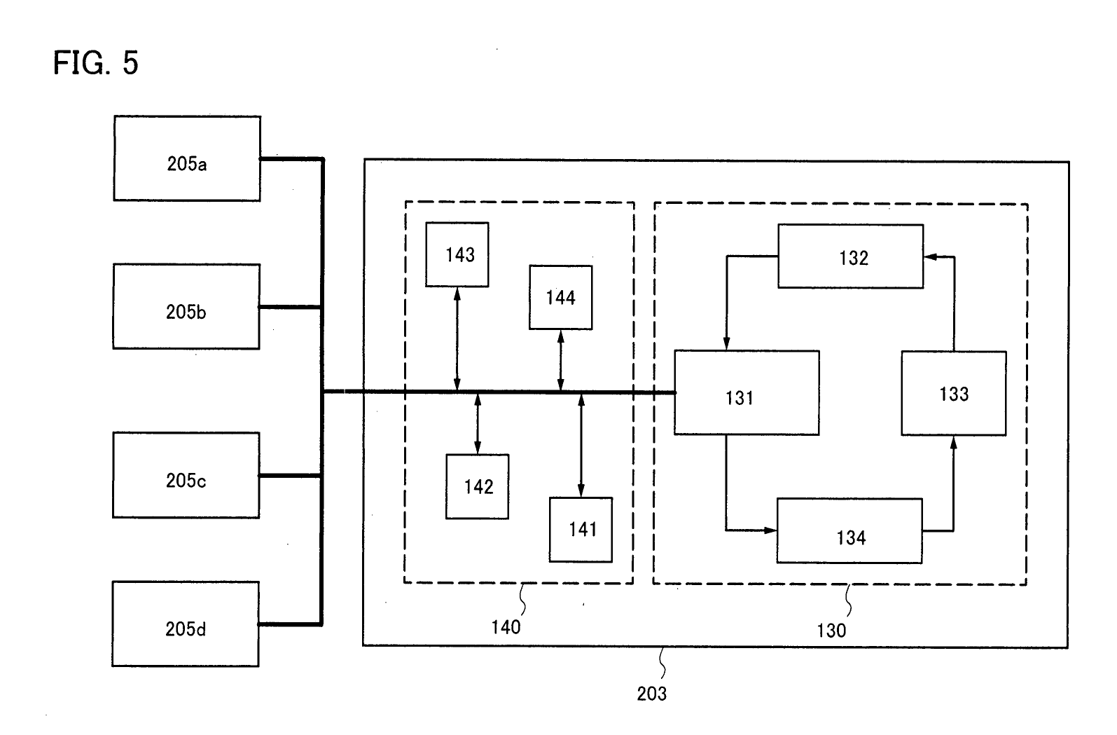

The reader/writer 205a to the reader/writer 205d are connected to a radio communication device 203 via a LAN (local area network) or the like. The radio communication device 203 communicates with a portable device 204 by radio and controls the reader/writer 205a to the reader/writer 205d. In addition, the radio communication device 203 detects the position of the RFID tag 202 based on signals from the reader/writer 205a to the reader/writer 205d. In that case, the radio communication device 203 may have a configuration illustrated in FIG. 2 without the R/W block 120, that is, a configuration with the Bluetooth communication block 130 and the control block 140 (see FIG. 5). In other words, the R/W block 120 can be replaced with the reader/writer 205a to the reader/writer 205d.

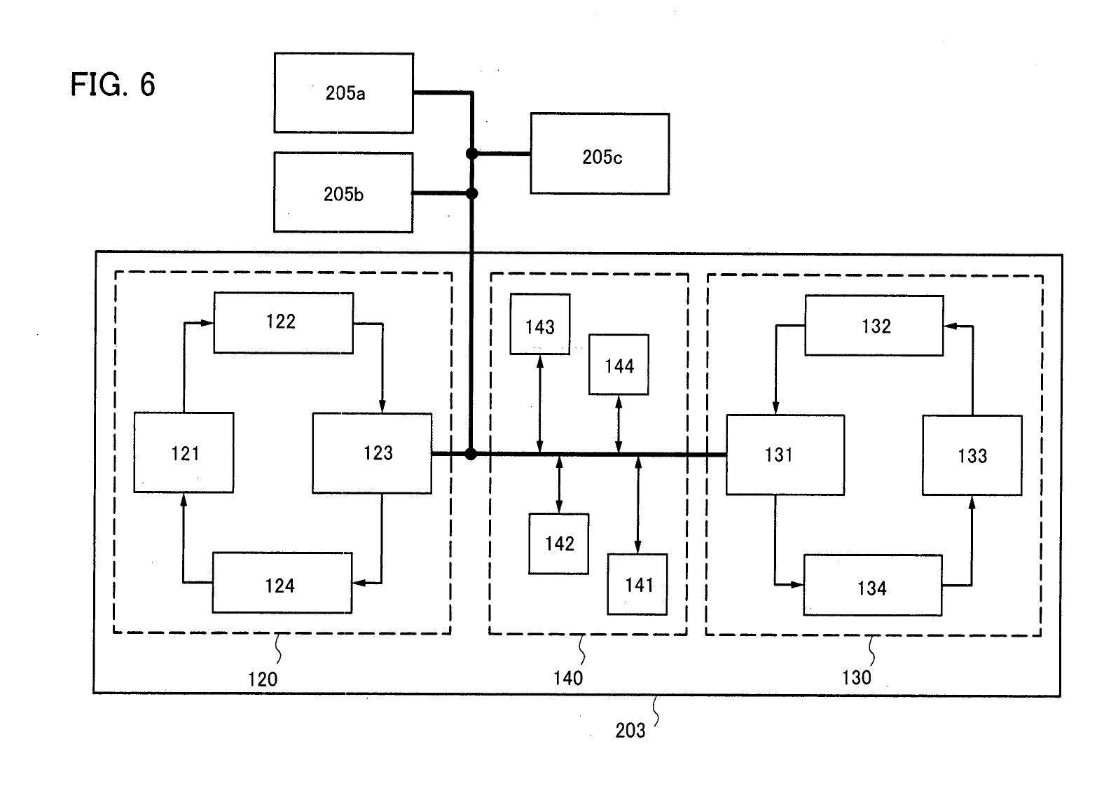

Alternatively, the radio communication device 203 may be configured to function as one of the readers/writers that detect the position of the RFID tag 202. In that case, the reader/writer 205a to the reader/writer 205c are connected to the control block 140 of the radio communication device 203 (see FIG. 6) like the R/W block 120 in the configuration illustrated in FIG. 2.

Note that the connection between the radio communication device 203 and the reader/writer 205a to the reader/writer 205d and the connection between each of the reader/writer 205a to the reader/writer 205d may be built over a wired network or a wireless network.

The transmission method of electromagnetic waves applied to the RFID tag 202 and the reader/writer 205a to the reader/writer 205d can be any of an electromagnetic coupling method, an electromagnetic induction method, a microwave method, and the like.

The reader/writer 205a to the reader/writer 205d output distance detection signals each having equal electric field strength. Hereinafter, signals output from the reader/writer 205a, the reader/writer 205b, the reader/writer 205c, and the reader/writer 205d are represented by Fa, Fb, Fc, and Fd, respectively (see FIG. 4).

When the distance between the RFID tag 202 and a reader/writer or the position of the RFID tag 202 is to be measured, the signal Fa to the signal Fd are transmitted so as not to overlap with each other. Therefore, the reader/writer 205a to the reader/writer 205d sequentially transmit their respective signals Fa to Fd so that the RFID tag 202 does not concurrently receive the signals from the plurality of readers/writers. The timings at which the reader/writer 205a to the reader/writer 205d transmit their respective signals Fa to Fd are controlled by the radio communication device 203.

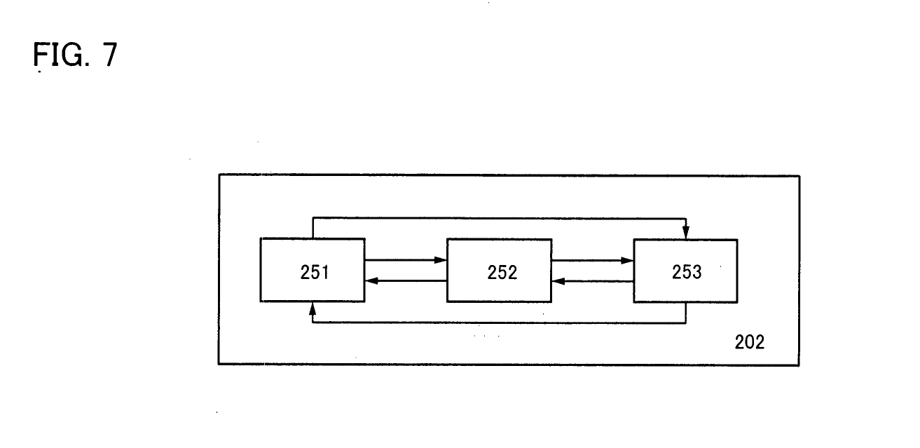

The RFID tag 202 has functions of receiving the signals Fa to Fd transmitted from the reader/writer 205a to the reader/writer 205d and transmitting signals Sa to Sd that are generated upon reception of the signals Fa to Fd. FIG. 7 is a block diagram illustrating the configuration of the RFID tag 202 in this embodiment mode. The RFID tag 202 in FIG. 7 includes an antenna 251, a signal oscillating portion 252, and a signal processing portion 253.

As illustrated in FIG. 7, the antenna 251 and the signal oscillating portion 252 communicate signals to each other, and the signal oscillating portion 252 and the signal processing portion 253 communicate signals to each other. The antenna 251 is a circuit which receives and transmits signals from/to the outside. That is, the signals Fa to Fd from the reader/writer 205a to the reader/writer 205d illustrated in FIG. 4 are received by the antenna 251 and the signals Sa to Sd are transmitted from the antenna 251.

The signal oscillating portion 252 has functions of oscillating a pulse signal based on the signal received by the antenna 251 and outputting the pulse signal. Therefore, the signal oscillating portion 252 has a pulse oscillation circuit. The pulse oscillation circuit has a function of oscillating a pulse signal whose frequency differs depending on the voltage of an input signal. Such a pulse oscillation circuit can be constructed from, for example, a rectifier circuit and a ring oscillator circuit which receives a signal from the rectifier circuit.

Note that the pulse signal herein means a signal whose voltage changes periodically. That is, the pulse signal is a wave whose voltage oscillates periodically like a square wave, a triangle wave, a sawtooth wave, or a sine wave, for example.

The signal processing portion 253 has a function of counting pulses of a pulse signal output from the signal oscillating portion 252. Therefore, the signal processing portion 253 has a counter which counts pulses of the pulse signal output from the signal oscillation portion 252.

The shape of the antenna 251 is not particularly limited. That is, the signal transmission method applied to the antenna 251 of the RFID tag 202 can be any of an electromagnetic coupling method, an electromagnetic induction method, a microwave method, and the like. The transmission method may be determined by a practitioner by appropriately taking into consideration the use of the system. An antenna with an optimal length and shape may be provided in accordance with the transmission method.

The position detection method described in this embodiment mode is a method in which the distance between an RFID tag and a reader/writer and the position of the RFID tag are detected by detecting a decrease in electric field strength in accordance with an increase in propagation distance of a signal in air.

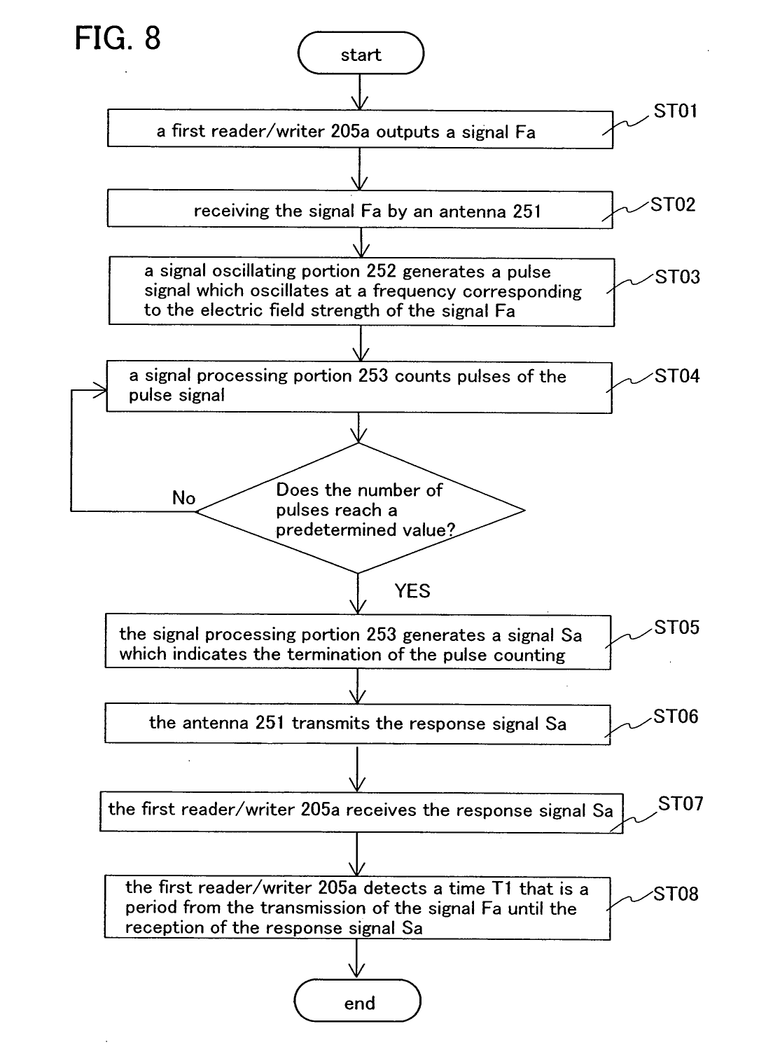

The position detection method illustrated in FIG. 4 will be described with reference to a flow chart shown in FIG. 8. Note that described below is a case where the article 201 is detected to be located in the section 200 among a plurality of sections upon access from the portable device 204 in search of the searched article (the article 201), and further, the position of the article 201 within the section 200 is specified. In addition, although described below is a case where four readers/writers are provided, the number of the readers/writers is not limited to four.

First, after the article 201 to which the RFID 202 is attached is detected to be located in the section 200, the first reader/writer 205a outputs the signal Fa in order to detect the distance between the RFID tag 202 and the first reader/writer 205a (Step ST01). Note that in which of the plurality of sections the article 201 is located can be detected by using the reader/writer 205a to the reader/writer 205d.

The RFID tag 202 receives the signal Fa from the reader/writer 205a at the antenna 251 (Step ST02).

The signal Fa received at the antenna 251 is output to the signal oscillating portion 252. The signal oscillating portion 252 generates a pulse signal which oscillates at a frequency corresponding to the electric field strength of the input signal Fa (Step ST03). Such a pulse signal can be generated by rectifying and smoothing the signal Fa received at the antenna 251 to generate a DC voltage, and oscillating a pulse signal in the oscillator circuit which uses the DC voltage as a power supply.

The pulse signal oscillated by the signal oscillating portion 252 is input to the signal processing portion 253. The signal processing portion 253 counts pulses of the pulse signal until the number of pulses reaches a predetermined value (Step ST04).

When the number of pulses has reached a predetermined value, the signal processing portion 253 generates a signal Sa (response signal) which indicates the termination of the pulse counting (Step ST05). The response signal Sa is output from the signal processing portion 253 to the antenna 251. Then, the antenna 251 transmits the response signal Sa (Step ST06). The reader/writer 205a receives the response signal Sa from the RFID tag 202 (Step ST07). Upon receiving the response signal Sa, the reader/writer 205a detects a time T1 that is a period from the transmission of the signal Fa until the reception of the response signal Sa (Step ST08). Here, the time T1 is referred to as a response time T1.

Note that the response time T1 is determined by the oscillating frequency of a pulse signal oscillated by the signal oscillating portion 252 within the RFID tag 202. In addition, the oscillating frequency of the pulse signal is determined by the electric field strength of the signal Fa received by the RFID tag 202. The electric field strength of the signal Fa received by the RFID tag 202 is determined by the distance between the RFID tag 202 and the first reader/writer 205a.

As the distance between the RFID tag 202 and the reader/writer 205a increases, the electric field strength of the signal Fa received by the RFID tag 202 becomes weaker, which results in decreased oscillating frequency of a pulse signal. As a result, time required for the signal processing portion 253 to count pulses becomes longer, and the response time T1 measured by the reader/writer 205a becomes longer. That is, since the response time T1 measured by the reader/writer 205a corresponds to the frequency of the pulse signal oscillated by the signal oscillating portion 252, the distance between the RFID tag 202 and the reader/writer 205a can be detected from the response time T1.

The operations of the step ST01 through the step ST08 are sequentially conducted with the second reader/writer 205b, the third reader/writer 205c, and the fourth reader/writer 205d, so that the reader/writer 205b to the reader/writer 205d detect a response time T2, a response time T3, and a response time T4, respectively. Selection of which reader/writer to communicate with the RFID tag 202 is controlled based on an instruction from the radio communication device 203. Note that in order to specify the position of the RFID tag 202 in three-dimensional coordinates, the response times have to be measured with at least four readers/writers. When there are more than four readers/writers in the section 200, not all the readers/writers are required to be used for measuring the response times.

The reader/writer 205a to the reader/writer 205d positioned in the section 200 transmit the measured response times T1 to T4 to the radio communication device 203 via a LAN (local area network) and the like. Based on the response times T1 to T4 transmitted from the reader/writer 205a to the reader/writer 205d, the radio communication device 203 measures a distance D1 between the reader/writer 205a and the RFID tag 202, a distance D2 between the reader/writer 205b and the RFID tag 202, a distance D3 between the reader/writer 205c and the RFID tag 202, and a distance D4 between the reader/writer 205d and the RFID tag 202. The position (spacial coordinates) of the article 201 to which the RFID tag 202 is attached can be specified based on the distances D1 to D4 and the positional information (spacial coordinates, or more specifically, relative coordinates) of the reader/writer 205a to the reader/writer 205d.

After that, the positional information of the article 201 is transmitted to the portable device 204 via the Bluetooth communication block 130 of the radio communication device 203.

In this manner, by providing a plurality of readers/writers in each section and measuring the distance between the plurality of readers/writers and an RFID tag attached to an article, an accurate position of the RFID tag within the section can be detected. Therefore, by accessing a radio communication device using a portable device, users can know in which of a plurality of sections the RFID tag is located as well as the position of the article within the section where the article is located. Therefore, the searched article can be efficiently detected in a short time.

In addition, by providing a plurality of readers/writers in each section as illustrated in this embodiment mode, it is possible to reduce the influence of intercepting objects existing around the article.

This embodiment mode can be implemented as appropriate in combination with the configuration of the article management system illustrated in the preceding embodiment mode.

This application is based on Japanese Patent Application serial no. 2007-142387 filed with Japan Patent Office on May 29, 2007, the entire contents of which are hereby incorporated by reference.

What is claimed is:

1. An article management system for managing the whereabouts of an article existing in any of a plurality of sections, comprising:
a radio communication device provided in each section;
an RFID tag communicable with the radio communication device provided in each section by radio; and
a portable device communicable with the radio communication device provided in each section by radio,
wherein the RFID tag is attached to the article,
wherein the article is detected through communication between the RFID tag and one of the radio communication device provided in each section, and
wherein in which of the plurality of sections the article exists is specified through communication between the portable device and the radio communication device provided in each section.

2. The article management system according to claim 1,
wherein the radio communication device includes a first antenna and a second antenna,
wherein the radio communication device communicates with the RFID tag via the first antenna, and
wherein the radio communication device communicates with the portable device via the second antenna.

3. The article management system according to claim 1, wherein Bluetooth® is utilized as a communication method between the radio communication device and the portable device.

4. An article management system for managing the whereabouts of a plurality of articles existing in any of a plurality of sections, comprising:
a radio communication device provided in each section;
RFID tags communicable with the radio communication device provided in each section by radio; and
a portable device communicable with the radio communication device provided in each section by radio,
wherein the RFID tags are attached to the articles, respectively,
wherein the articles existing in each section are detected through communication between the RFID tags and the radio communication device provided in each section, and
wherein in which of the plurality of sections each of the plurality of articles exists is specified through communication between the portable device and the radio communication device provided in each section.

5. The article management system according to claim 4,
wherein the radio communication device includes a first antenna and a second antenna,
wherein the radio communication device communicates with the RFID tags via the first antenna, and
wherein the radio communication device communicates with the portable device via the second antenna.

6. An article management system for managing the whereabouts of an article existing in any of a plurality of sections, comprising:
a radio communication device provided in each section;
a plurality of readers/writers provided in each section;
an RFID tag communicable with the plurality of readers/writers by radio; and
a portable device communicable with the radio communication device provided in each section by radio,
wherein the plurality of readers/writers provided in each section are operationally connected to the radio communication device provided in said section,
wherein the RFID tag is attached to the article,
wherein the article and position of the article are detected through communication between the RFID tag and the plurality of readers/writers, and
wherein in which of the plurality of sections the article exists and position of the article within said section are specified through communication between the portable device and the radio communication device provided in each section.

7. The article management system according to claim 6, wherein at least three readers/writers are provided in each section.

8. The article management system according to claim 6, wherein Bluetooth® is utilized as a communication method between the radio communication device and the portable device.

9. An article management system for managing the whereabouts of an article existing in a first section or a second section, comprising:
a first radio communication device provided in the first section;
a second radio communication device provided in the second section;
an RFID tag communicable with the first and second radio communication devices by radio; and
a portable device communicable with the first and second radio communication devices by radio,
wherein the RFID tag is attached to the article,
wherein the article is detected through communication between the RFID tag and one of the first radio communication device provided in the first section and the second radio communication device provided in the second section, and
wherein in which of the first section and the second section the article exists is specified through communication between the portable device and the first radio communication device provided in the first section, and between the portable device and the second radio communication device provided in the second section.

10. The article management system according to claim 9,
wherein each of the first and second radio communication devices includes a first antenna and a second antenna,
wherein each of the first radio communication device and the second radio communication device communicates with the RFID tag via the first antenna, and
wherein each of the first radio communication device and the second radio communication device communicates with the portable device via the second antenna.

11. The article management system according to claim 9, wherein Bluetooth® is utilized as a communication method between the first and second radio communication devices and the portable device.
